(19) United States
(12) Patent Application Publication
(10) Pub. No.: US 2020/0215961 A1
(43) Pub. Date: Jul. 9, 2020

(54) LIGHT SIGNAL ASSEMBLY FOR HEADWEAR AND METHOD OF USING THE SAME

(71) Applicant: Reem Jafar ALATAAS, Bridgeport, CT (US)

(72) Inventor: Reem Jafar ALATAAS, Bridgeport, CT (US)

(21) Appl. No.: 16/242,543

(22) Filed: Jan. 8, 2019

(51) Int. Cl. B60Q 1/00; A42B 3/04; F21V 33/00; H05B 33/08; H05B 37/02

(52) U.S. Cl. CPC B60Q 1/0047; A42B 3/044; H05B 37/0272; H05B 33/0857; F21V 33/0004

(57) ABSTRACT

A light signal assembly for headgear and method of using the same may be provided. The light signal assembly may include a light-emitting display strip; a plurality of light sources mounted at predetermined locations along the light-emitting display strip, the plurality of light sources capable of emitting light from a front surface thereof; a microprocessor operatively connected to the plurality of light sources, the microprocessor having a memory with at least one stored control program executable by the microprocessor for controlling illumination of the plurality of light sources; a remote controller in wireless communication with the microprocessor for transmitting a desired lighting sequence instruction thereto; and a power source for supplying electrical power to the light signal assembly. The light signal assembly may provide visual confirmation of a wearer's intended movement, and increase said wearer's visibility.

### BACKGROUND

Safety is an important concern among vehicle operators and pedestrians alike. Often cyclists and drivers share the same route and clearly communicating a cyclist's intended direction of travel to the drivers and other cyclists decreases the risk of accidents. Cyclists often communicate their intended direction of travel using conventional hand signals. Unfortunately, however, these hand signals go unnoticed, especially under circumstances of poor ambient illumination. In response to the dangers of riding, cyclists often wear protective helmets for safety. It would, therefore, be beneficial to incorporate further safety features, such as illumination, into the protective helmet for increased visibility. In addition, the illumination assembly should be adaptable to fit around any conventional article of headgear.

The foregoing “background” description is for the purpose of generally presenting the context of the disclosure. Work of the inventor, to the extent it is described in this background section, as well as aspects of the description which may not otherwise qualify as prior art at the time of filing, are neither expressly or impliedly admitted as prior art against the present invention. The foregoing paragraphs have been provided by way of general introduction, and are not intended to limit the scope of the following claims. The described embodiments, together with further advantages, will be best understood by reference to the following detailed description taken in conjunction with the accompanying drawings.

### SUMMARY

According to an exemplary embodiment, a light signal assembly for headgear may be provided herein. The light signal assembly may comprise a light-emitting display strip having a left turn signal portion, a right turn signal portion, a right sidelight portion, a left sidelight portion, a backlight portion, and a front headlight portion; a plurality of light sources mounted at predetermined locations along the light-emitting display strip, the plurality of light sources capable of emitting light from a front surface thereof; a microprocessor operatively connected to the plurality of light sources via at least one flexible electrical cable, the microprocessor having a memory with at least one stored control program executable by the microprocessor for controlling illumination of the plurality of light sources; a remote controller in wireless communication with the microprocessor for transmitting a desired lighting sequence instruction thereto; and a power source for supplying electrical power to the light signal assembly.

### BRIEF DESCRIPTION OF THE FIGURES

Advantages of embodiments of the present invention will be apparent from the following detailed description of the exemplary embodiments. The following detailed description should be considered in conjunction with the accompanying figures in which:

FIG. 1 illustrates a perspective view of an exemplary embodiment of a light signal assembly in accordance with the present invention;

FIG. 2A illustrates a front perspective view of a protective helmet with the exemplary light signal assembly of FIG. 1 mounted thereon;

FIG. 2B illustrates a rear perspective view of the protective helmet with the exemplary light signal assembly mounted thereon;

FIG. 2C illustrates a left perspective view of the protective helmet with the exemplary light signal assembly mounted thereon;

FIG. 2D illustrates a right perspective view of the protective helmet with the exemplary light signal assembly mounted thereon;

FIG. 3 illustrates a perspective view of an exemplary remote controller used in conjunction with a light signal assembly of the present invention; and

FIG. 4 illustrates a table showing the operation of an exemplary light signal assembly.

### DETAILED DESCRIPTION OF THE FIGURES

Aspects of the present invention are disclosed in the following description and related figures directed to specific embodiments of the invention. Those skilled in the art will recognize that alternate embodiments may be devised without departing from the spirit or the scope of the claims. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention,” “embodiments,” or “invention” do not require that all embodiments of the invention include the discussed feature, advantage, or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

The present invention relates generally to a light notification system, and in particular to an adaptive light signal assembly for headgear or the equivalent thereof. The light signal assembly may be universally affixable to an exterior surface of an article of headgear, such as a protective helmet, to enhance the visibility and safety of a wearer, especially in vehicular and pedestrian traffic. It should be appreciated that headgear may take any desired form, including but not limited to, various sporting helmets, such as bicycle, scooter, motorcycle, skateboarding, and equestrian helmets, as well as construction hard-hats, safety helmets, military helmets, baseball hats, and the like.

According to an exemplary embodiment, a light signal assembly for headgear may be described herein. The light signal assembly may provide visual confirmation of a wearer's intended movement (e.g., to continue forward, to turn or bear right, to turn or bear left, to stop, etc.) in a manner that is readily observable and understandable by passersby. The light signal assembly may include an elongated flexible light strip, the light strip being generally conformable to the curved surfaces of the headgear, and mountable thereto around the entire circumference. The light strip may be populated with a plurality of light sources that are configured to create meaningful direction signals when controllably actuated via a controller. For example, in some exemplary embodiments, the light strip may include turn signals, sidelights, a backlight, and a front headlight. The turn signals and/or sidelights may serve as directional indicators, while the backlight and/or sidelights may further serve as a brake indicator. In addition, the front headlight may increase wearer visibility, especially in low or poor ambient light environments, by projecting an illuminating beam toward the path ahead.

The plurality of light sources may be connected in series, parallel or a combination thereof on at least one conducive base acting as an electrical connector. In some exemplary embodiments, the conductive base may form a physical mounting platform; alternatively, the conductive base may be mounted on any suitable substrate (e.g., plastic) to provide an elongated light strip. The conductive base may operatively connect to a power source to activate the light sources.

An electrical control unit may be mounted within the light-emitting display strip and be configured to selectively control the plurality of light sources. The electrical control unit may be, for instance, disposed within the backlight portion of the light-emitting display strip. In one exemplary embodiment, the electrical control unit may include a microprocessor having a memory with at least one stored control program executable by the microprocessor for controlling the illumination of the plurality of light sources, and control circuity for activating/deactivating the individual light sources. It should be appreciated, however, that the electrical control unit may be equipped with any number of microprocessors, memory storage units, and electrical components suitable for controlling the plurality of light sources within the light signal assembly. For example, changes in the supply of electrical current may dim, brighten, and turn on or off the light sources as may be understood by a person having ordinary skill in the art. The electrical control unit may also regulate various lighting characteristics, such as, but not limited to, the quantity, frequency, intensity, and color of the light sources.

In some exemplary embodiments, a remote controller may wirelessly communicate (e.g., by Wi-Fi or BLUETOOTH) with the electrical control unit to transmit a desired light sequence instruction thereto. In other exemplary embodiments, these components may communicate via a wired connection, such as a USB or Ethernet cable.

The process data and light sequence instructions may be stored in memory. These processes and instructions may also be stored on a storage medium disk such as a hard drive (HDD) or portable storage medium. Further, the claimed advancements are not limited by the form of the computer-readable media on which the instructions of the inventive process are stored. For example, the instructions may be stored on RAM, ROM, PROM, EPROM, EEPROM, hard disk or any other information processing device.

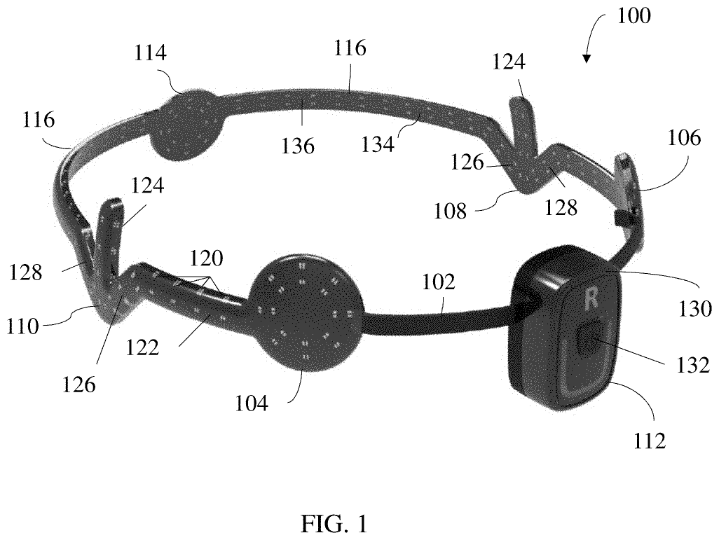

Referring now to the figures, FIG. 1 may illustrate an exemplary embodiment of a light signal assembly 100 affixable to an article of headgear. The light signal assembly 100 may include a light-emitting display strip 102 having a left turn signal portion 104, a right turn signal portion 106, a right sidelight portion 108, a left sidelight portion 110, a backlight portion 112, and a front headlight portion 114. The light-emitting display strip 102 may further include elongated auxiliary portions 116 extending between the front headlight portion 114 and each respective sidelight portion 108, 110. As shown in the exemplary embodiment, the backlight portion 112 may be positioned between the right turn signal portion 106 and the left turn signal portion 104. The portion of light-emitting display strip 102 extending between the backlight portion 112 and each respective turn signal 104, 106 may be size-adjustable, and may not include light sources. The front headlight portion 114 may be positioned between the right sidelight portion 108 and the left sidelight portion 110. The backlight portion 112 may include space to print a customized graphic or logo thereto.

In some exemplary embodiments, and as illustrated in exemplary FIG. 1, the right sidelight portion 108 and the left sidelight portion 110 may each include an elongated vertical indicator 124 having a right branch indicator 126 and a left branch indicator 128 extending upwardly and radially outwardly from a respective bottom side thereof. The left turn signal portion 104 and the right turn signal portion 106 may each include a circular indicator.

A plurality of light sources 120 may be mounted at predetermined locations along the light-emitting display strip 102, the plurality of light sources 120 being capable of emitting light, and thus being visible, from a front surface 122 of the display strip 102. The plurality of light sources 120 may create turn signals, sidelights, a backlight, and a front headlight on respective portions of the display strip 102. As illustrated in exemplary FIG. 1, light sources 120 may be arranged at regularly-spaced apart intervals along the upper and lower edges of the display strip 102. The left and right signal portions 104, 106 may include first and second circumferentially spaced light sources that extend into annular rings. The backlight portion 112 may further include a light source having a U-shaped configuration with two longitudinally extending leg members joined together by a U-bend portion. It should be appreciated that the light sources 120 may be positioned in any suitable configuration along the display strip 102, as would be understood by a person having ordinary skill in the art.

In some exemplary embodiments, the light sources 120 may comprise light-emitting diodes (LEDs). The LEDs may be multi-color and color controllable. In some exemplary embodiments, the LEDs are specifically positioned with a particular density and angle to provide a certain intensity of light. It should be appreciated, however, that the light sources may include any suitable light source as would be understood by a person having ordinary skill in the art, including but not limited to, incandescent bulbs, lasers, halogen bulbs, fluorescent bulbs, or any other suitable light source. Further, the plurality of light sources 120 may include a single source, multiple sources, or any combination of desired sources, as may be understood by a person having ordinary skill in the art.

A power source 130 may supply electrical power to the electrical components of the light signal assembly 100. The power source 130 may be mounted within the backlight portion 112 of the light-emitting display strip 102. A power switch 132, e.g., a depressible button, may be coupled to the power source 130 for turning the light signal assembly 100 on and off. In some exemplary embodiments, a user may need to depress the power switch 132 for approximately 1.5 seconds in order to power on/off the light assembly. The power source 130 may take any suitable form, for example one or more conventional batteries, rechargeable batteries, rechargeable power source, or solar converter means. The power source 130 may interface with a USB charging port (not shown) for recharging the same.

In some exemplary embodiments, the power switch 132 may enable different activation modes in addition to the conventional on and off functionality. The activation modes may pertain specifically to the light sequence of the backlight portion 112. The first mode may activate continuous illumination of the backlight for the duration of use, while the second mode may activate intermittent flashing of the backlight (or vice versa). A user may select one of the two modes by a specific press or shortened depression of the power button 132.

An adhesive 134 may be disposed on a back surface 136 of the light-emitting display strip 102 to secure the light signal assembly 100 to an article of headgear. In some exemplary embodiments, the adhesive 134 may include a pressure-sensitive adhesive tape. In other exemplary embodiments, the adhesive may include any other suitable adhesive known in the art, such as a sub-laminate adhesive layer, glue, and the like, to facilitate adhesion of the light signal assembly to an exterior surface of headgear.

In some exemplary embodiments, the light signal assembly 100 may be designed in accordance with the IPX5 Waterproof standard.

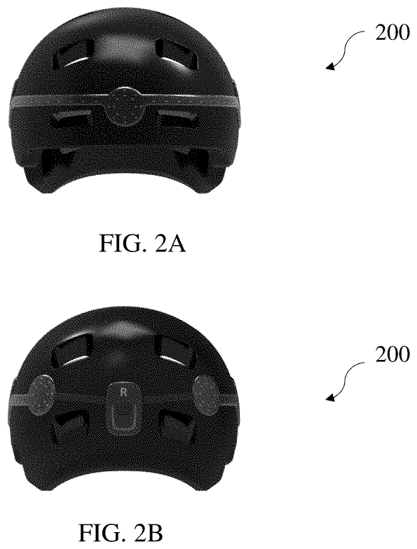

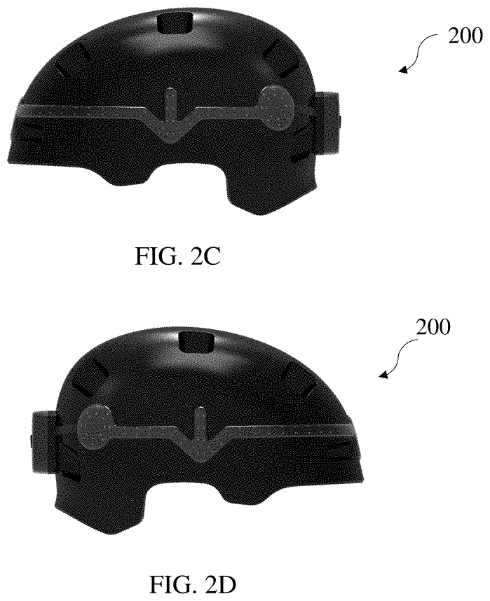

FIGS. 2A-2D may illustrate an exemplary embodiment of a protective helmet 200 having a light signal assembly mounted thereon. FIG. 2A may illustrate a front perspective view, FIG. 2B may illustrate a rear perspective view, and FIGS. 2C-D may illustrate side perspective views.

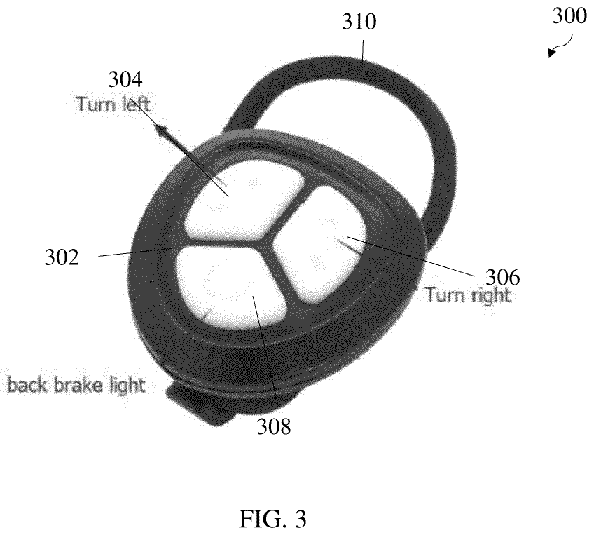

FIG. 3 may illustrate an exemplary embodiment of a remoter controller 300 for use in conjunction with a light signal assembly of the present invention. The remote controller 300 may include a user interface 302 having a plurality of control buttons. Each control button may correspond to and be associated with a desired lighting sequence instruction, such that depression of the control button transmits the corresponding lighting sequence instruction to the electrical control unit for execution within the light signal assembly. As illustrated in exemplary FIG. 3, for example, control button 304 may activate a left turn signal sequence, control button 306 may activate a right turn signal sequence, and control button 308 may activate a brake signal sequence. Further, the remote controller 300 may be provided with attachment means 310 for securing the controller 300 to a supplemental surface, for instance a bicycle handle.

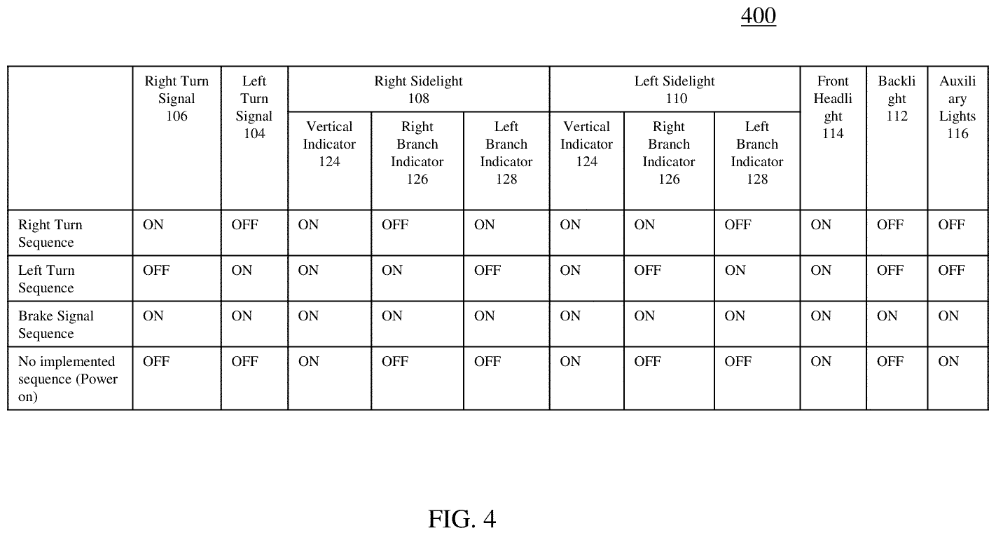

Exemplary operations of each lighting sequence instruction may be illustrated in FIG. 4, showing the activation of light sources mounted on different portions of the display strip. Table 400 shows, for example, different combinations of light activation depending on the user specified instruction. A left turn signal sequence may include, for instance, selective activation of the light sources disposed along the left turn signal portion 104, the left sidelight portion 124, 128, and the right sidelight portion 124, 126 of the light-emitting display strip. A right turn signal sequence may include selective activation of the light sources disposed along the right turn signal portion 106, the right sidelight portion 124, 128, and the left sidelight portion 124, 126 of the light-emitting display strip. Th left turn signal sequence and the right turn signal sequence may include intermittent flashing of the light sources over a 20-second interval. The brake signal sequence may include continuous illumination of all the plurality of light sources over a 10-second interval. In some exemplary embodiments, the brake light sequence emits red light and the turn signal sequences may emit a yellow or orange color light.

In some exemplary embodiments, activation of the power source may selectively illuminate all the plurality of light sources in a repetitive, sequential manner. For example, the front headlight portion 114 may illuminate, followed by the auxiliary portions 116, the sidelight portions 108, 110, and the turn signal portions 104, 106. In other exemplary embodiments, and as illustrated in FIG. 4, power activation may continuously illuminate the vertical indictors 124, the front headlight 114, and the auxiliary lights 116.

Alternatively, the light signal assembly may be operatively controllable by the adaptive light notification system disclosed in U.S. Pat. No. 9,457,709, entitled “BICYCLE HELMET WITH AN ADAPTIVE LIGHT NOTIFICATION SYSTEM THAT VARIES BRIGHTNESS,” which is hereby incorporated herein by reference in its entirety.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A light signal assembly for headgear, comprising:
a light-emitting display strip having a left turn signal portion, a right turn signal portion, a right sidelight portion, a left sidelight portion, a backlight portion, and a front headlight portion;
a plurality of light sources mounted at predetermined locations along the light-emitting display strip, the plurality of light sources capable of emitting light from a front surface thereof;
a microprocessor operatively connected to the plurality of light sources via at least one flexible electrical cable, the microprocessor having a memory with at least one stored control program executable by the microprocessor for controlling illumination of the plurality of light sources;
a remote controller in wireless communication with the microprocessor for transmitting a desired lighting sequence instruction thereto; and
a power source for supplying electrical power to the light signal assembly.

2. The light signal assembly of claim 1, further comprising:
an adhesive disposed on a back surface of the light-emitting display strip.

3. The light signal assembly of claim 2, wherein the adhesive is a pressure-sensitive adhesive tape.

4. The light signal assembly of claim 1, wherein the light-emitting display strip further comprises an elongated auxiliary portion located between the front headlight portion and each respective sidelight portion.

5. The light signal assembly of claim 1, wherein the light sources comprise light-emitting diodes.

6. The light signal assembly of claim 5, wherein the light-emitting diodes are color controllable, multi-color light-emitting diodes.

7. The light signal assembly of claim 1, wherein the right sidelight portion and the left sidelight portion each comprise an elongated vertical indicator having a right branch indicator and a left branch indicator extending upwardly and radially outwardly from a respective bottom side thereof.

8. The light signal assembly of claim 1, wherein the left turn signal portion and the right turn signal portion each comprise a circular indicator.

9. The light signal assembly of claim 1, wherein the remote controller further comprises a user interface having a plurality of control buttons, each control button being associated with a desired lighting instruction.

10. The light signal assembly of claim 9, wherein the desired lighting instructions comprise a left turn signal sequence, a right turn signal sequence, and a brake signal sequence.

11. The light signal assembly of claim 10, wherein the left turn signal sequence comprises activation of the light sources disposed along the left turn signal portion and the left sidelight portion of the light-emitting display strip.

12. The light signal assembly of claim 10, wherein the right turn signal sequence comprises activation of the light sources disposed along the right turn signal portion and the right sidelight portion of the light-emitting display strip.

13. The light signal assembly of claim 10, wherein the left turn signal sequence and the right turn signal sequence comprises intermittent flashing of the light sources over a 20-second interval.

14. The light signal assembly of claim 13, wherein light emitted during the intermittent flashing is a yellow or orange color.

15. The light signal assembly of claim 10, wherein the brake signal sequence comprises continuous illumination of all the plurality of light sources over a 10-second interval.

16. The light signal assembly of claim 15, wherein light emitted during the continuous illumination is a red color.

17. The light signal assembly of claim 1, wherein the power source is a battery.

18. The light signal assembly of claim 1, further comprising:
a USB charging port.

19. The light signal assembly of claim 7, wherein activation of the power source selectively illuminates the light sources disposed along the front headlight portion and the elongated vertical indicator.

20. The light signal assembly of claim 1, wherein the power source is disposed within the backlight portion of the light-emitting display strip.
